(19) United States
(12) Patent Application Publication
(10) Pub. No.: US 2009/0214904 A1
(43) Pub. Date: Aug. 27, 2009

(54) Integrated Fuel and Fuel Cell Device

(76) Inventor: Yu Zhou, Dublin, CA (US)

Correspondence Address: MORRISON & FOERSTER LLP, 755 PAGE MILL RD, PALO ALTO, CA, 94304-1018, US

(21) Appl. No.: 11/918,391

(22) PCT Filed: Apr. 14, 2006
(86) PCT No.: PCT/US06/14135

§ 371 Date: Jan. 26, 2009

Related U.S. Application Data
(60) Provisional application No. 60/671,773, filed on Apr. 14, 2005.

(51) Int. Cl. H01M 8/06; H01M 8/18

(52) U.S. Cl. 429/17; 429/19

(57) ABSTRACT

Described here is a device for generating electrical current via an electrochemical fuel cell that consumes hydrogen. The described device may be entirely or partially self-contained or may be made up of cooperating components. The device comprises at least and fuel and fuel cell components and those components may be integrated. The fuel is selected to produce hydrogen suitable for use in a variety of fuel cell designs that utilize hydrogen to produce electrical current. The fuel cell, in some variations, produces water and that water may be returned to the selected fuel source to create a self-sustaining supply of hydrogen for the fuel cell under load. The fuel cell may also contain a system for controlling the amount of water produced by the fuel cell that gets delivered to the solid fuel.

### CROSS REFERENCE TO RELATED APPLICATIONS

This application claims the benefit of U.S. Provisional Patent Application No. 60/671,773, which is hereby incorporated by reference in its entirety as if fully put forth below.

### FIELD

Described here is a device for generating electrical current via an electrochemical fuel cell that consumes hydrogen. The described device may be entirely or partially self-contained or may be made up of cooperating components. The device comprises a fuel source and fuel cell components and those components may be integrated. The fuel is selected to produce hydrogen for use in a variety of fuel cell designs that utilize hydrogen to produce electrical current. The fuel cell, in some variations, produces water and that water may be returned to the selected fuel source to create a self-sustaining supply of hydrogen for the fuel cell under load.

### BACKGROUND

In the technological arena of devices that store and deliver electrical energy, many conventional chemical batteries have three disadvantages: 1.) They have limited capacity in terms of energy density, whether that density is measured in terms of watt-hours per unit volume or watt-hours per unit mass of the device. This capacity limitation impacts the ability of the current chemical battery to operate under continuous load. Even rechargeable batteries are often limited to 4-5 hours of continuous usage. 2.) They have a relatively short shelf-life, often less than 3 to 5 years. 3.) Many modern batteries include harsh or toxic chemicals that pose long-term environmental hazards.

Devices that deliver electrical energy without some of the drawbacks of conventional batteries are fuel cell devices. However, many fuel cell configurations have drawbacks of their own. For instance, some designs utilize a fuel supply that is external to the device. The proton exchange membrane fuel cell (PEMFC) uses oxygen and hydrogen. The oxygen is typically taken from the air but the hydrogen is typically supplied as a clean gas from an external hydrogen supply, such as a storage tank or other external source in which the hydrogen is generated. Although such fuel cells may be acceptable for providing electrical energy to stationary loads, these configurations are not currently considered appropriate for movable or portable loads, which may be found in consumer electronic devices. Additionally, the very presence of an external fuel supply renders them impractical (perhaps, even, unsafe) for use in applications involving remote devices, such as safety devices or alarm sensors situated within a building structure.

The described devices are configured to supply electrical energy to a variety of loads. The devices are powered by a fuel that is typically quite stable and has a high energy density. The devices may also be designed in such a way that they are suitable for portable or remote use.

### SUMMARY OF THE INVENTION

1. A device for generating electrical energy, the device comprising: at least one fuel cell capable of generating electricity and water when fed hydrogen and oxygen, and at least one solid fuel source comprising a solid fuel, wherein the solid fuel source is configured to produce hydrogen for use by said at least one fuel cell when reacted with the water and wherein the solid fuel source and the fuel cell are configured so that an amount of the water produced by the fuel cell is directed into the solid fuel source to react with the solid fuel to produce hydrogen for use by the fuel cell.

2. The device according to summary paragraph 1 wherein the solid fuel source comprises at least one member selected from metals; alkali metals; alkaline earth metals; hydride salts of metals, alkali metals, and alkaline earth metals and complex salts thereof; and borohydride salts of alkali metals, alkaline earth metals, ammonium, and alkyl ammonium.

3. The device according to summary paragraph 1 wherein the solid fuel source comprises at least one member selected from.

4. The device according to summary paragraph 1 wherein the solid fuel source comprises at least one member selected from sodium, lithium, potassium, and rubidium.

5. The device according to summary paragraph 1 wherein the solid fuel source comprises at least one member selected from MgH4, NaAlH4, LiAlH4, KAlH4, NaGaH4, LiGaH4, KGaH4, Mg(AlH4)2, 2Li3AlH6, Na3AlH6, and Mg2NiH4.

6. The device according to summary paragraph 1 wherein the solid fuel source comprises at least one member from NaBH4, LiBH4, KBH4, Mg(BH4)2, Ca(BH4)2, NH4BH4, and (CH3)4NH4BH4.

7. The device according to summary paragraph 6, wherein the solid fuel comprises NaBH4.

8. The device according to summary paragraph 1 wherein the solid fuel source comprises at least two members selected from the members recited in summary paragraphs 2-6.

9. The device according to summary paragraphs 2-8 further comprising a catalyst for catalyzing the reaction of the solid fuel to produce hydrogen.

10. The device according to summary paragraph 9 wherein the catalyst is present in an amount of 0.1 wt %-10 wt %.

11. The device according to summary paragraphs 3-10 further comprising a stabilizer for stabilizing the reaction of the solid fuel to produce hydrogen.

12. The device according to any of the above summary paragraphs further comprising a water barrier adjacent the at least one fuel cell, wherein the water barrier is configured to be permeable to oxygen and substantially impermeable to water.

13. The device according to summary paragraph 12 wherein the water barrier comprises PTFE.

14. The device according to any of the above summary paragraphs comprising a single fuel cell.

15. The device according to any of the above summary paragraphs comprising multiple fuel cells.

16. The device according to any of the above summary paragraphs further comprising an activator containing an activating agent, wherein the activator is configured to release the activating agent to the device to initiate the generation of electricity.

17. The device according to summary paragraph 16 wherein the activating agent is water.

18. The device according to summary paragraph 18 wherein the activating agent is hydrogen.

19. The device according to summary paragraphs 16, 17, or 18 wherein the device further comprises an activation barrier, wherein the activation barrier is configured to prevent the activating agent from releasing into the device and wherein the activation barrier is configured to be modified to allow the activator to release the activating agent to the device.

20. The device according to summary paragraph 19 wherein the activation barrier is comprised of a material which is impermeable to the activating agent.

21. The device according to any of the above summary paragraphs wherein the fuel source is a removable.

22. The device according to any of the above summary paragraphs further comprising a water control system, wherein the water control system is configured to control the passage of the water produced by the fuel cell back to the fuel source.

23. The device according to summary paragraph 22 wherein the water control system comprises a pressure sensitive switch which is configured to prevent the water produced by the fuel cell from reaching the fuel source when the pressure in the system is above a critical value.

24. The device according to summary paragraph 22 wherein the water control system comprises a pressure sensitive regulator which is configured to prevent the water produced by the fuel cell from reaching the fuel source when the pressure in the system is above a critical value and is configured to regulate the amount of water which passes the water control system to the fuel source based on the pressure in the system, below the critical pressure.

25. The device according to summary paragraph 23 wherein the pressure sensitive switch is mechanical.

26. The device according to summary paragraph 23 wherein the pressure sensitive switch is a chemical material having openings the size of which are sensitive to the pressure in the system.

27. The device according to summary paragraph 24 wherein the pressure sensitive regulator is mechanical.

28. The device according to summary paragraph 24 wherein the pressure sensitive regulator is a chemical material having openings the size of which are sensitive to the pressure in the system.

29. The device according to summary paragraphs 24, 25, 26, 27, or 28 further comprising a water storage container in communication with the fuel cell and the fuel source for storing the water produced by the fuel cell which is prevented from entering the fuel source.

30. The device according to any of the above summary paragraphs wherein the solid fuel source contains individual capsules which contain the solid fuel and a reaction product, wherein the capsules are permeable to the water and the hydrogen but.

31. The device according to summary paragraph 29, wherein the water storage container contains a foam material configured to absorb the water.

32. The device according to summary paragraph 31 wherein the foam material is a hydrogel.

33. The device according to summary paragraphs 26, 28 wherein the chemical material is selected from a group consisting of metal, PTFE, Nylon, carbon, and polymers such as Polyurethane, and poly 2-(acrylamindo)-2-methylpropanesulfonic acid (PAMPS).

34. The device according to summary paragraph 30 wherein the capsules are made from a pressure sensitive material which is configured to prevent the passage of water to the solid fuel contained in the capsules when a pressure in the system is at or above a critical pressure.

35. The device according to summary paragraph 34 wherein the chemical material is selected from a group consisting of metal, PTFE, Nylon, carbon, and polymers such as Polyurethane, and poly 2-(acrylamindo)-2 methylpropanesulfonic acid (PAMPS).

36. A method for generating electricity the method comprising: reacting a solid fuel with water to generate hydrogen; converting the hydrogen in a fuel cell to electricity and water; directing an amount of the water produced by the hydrogen fuel cell to the solid fuel to generate hydrogen;

37. The method according to summary paragraph 36 further comprising: controlling the amount of water which is directed to the solid fuel source, wherein the amount of water which gets directed to the solid fuel source depends on an electrical demand.

38. The method according to summary paragraph 37 wherein a decrease in electrical demand is manifested by an increase in a pressure, and wherein the pressure is used to control the amount of water gets directed to the solid fuel source.

39. The method according to summary paragraphs 36, 37 or 38 further comprising: activating the solid fuel by introducing an activating agent from an activator.

40. The method according to summary paragraph 39 wherein the activating agent is selected from a group consisting of H2 and H2O.

41. The method according to any one of summary paragraphs 36-40 wherein the number of moles of hydrogen produced per total mass of solid fuel and water used is increased when the water which reacts with the solid fuel is the water produced by the fuel cell.

42. The method according to any one of summary paragraphs 36-41 wherein the solid fuel solid fuel source comprises at least one member selected from sodium, lithium, potassium, and rubidium.

43. The method according to any one of summary paragraphs 36-41 wherein the solid fuel solid fuel source comprises at least one member selected from MgH4, NaAlH4, LiAlH4, KAlH4, NaGaH4, LiGaH4, KGaH4, Mg(AlH4)2, 2Li3AlH6, Na3AlH6, and Mg2NiH4.

44. The method according to any one of summary paragraphs 36-41 wherein the solid fuel solid fuel source comprises at least one member from NaBH4, LiBH4, KBH4, Mg(BH4)2, Ca(BH4)2, NH4BH4, and (CH3)4NH4BH4.

### BRIEF DESCRIPTION OF THE DRAWINGS

FIG. 1 shows a schematic depiction of the components comprising the described device;

FIG. 2 is a schematic of the process for recycling the water produced by the fuel cell;

FIG. 3 is a schematic depiction of a water control system comprising a pressure control switch;

FIG. 4 is a schematic depiction of a water control system comprising a pressure control switch and a water storage container;

FIG. 5 is a depiction of a type of described device;

FIG. 6A depicts a capsule for containing the fuel in the fuel source;

FIG. 6B depicts multiple capsules within the fuel source;

FIG. 7 is a depiction of a type of described device containing four fuel cells;

FIG. 8 is a depiction of a type of described device having a removable fuel cartridge;

FIG. 9 is a depiction of a type of described device containing six fuel cells;

FIG. 10 is a depiction of a type of described device containing four fuel cell and a hollow interior;

FIG. 11 is a depiction of a type of described device;

FIGS. 12A-12F depicts different forms of the described device;

FIGS. 13A-13D show schematic variations of the described device depicting structures suitable for activating the fuel.

FIG. 14 depicts an exemplary device containing a solid fuel source having capsules, a water control system, a fuel cell, and a water barrier.

### DETAILED DESCRIPTION

In general, the described device includes hydrogen producing fuel and at least one fuel cell that produces electrical current by consuming that hydrogen. In the described device the fuel source may be integrated with the fuel cell devices and configured to generate electrical energy via a design in which a solid, hydrogen-generating fuel is used to supply hydrogen to the fuel cell. The interaction between the fuel cell and the fuel source may be interactive in such a way that allows hydrogen from the solid fuel to be readily available to the fuel cell for the process of producing electricity, and (in the instances where the fuel cell produces water) allows the water produced by the fuel cell to be readily available to react with the solid fuel. This interaction may be viewed as creating a continual supply of hydrogen fuel for the fuel cell, at least until the fuel is depleted. Other variations of the described device are substantially self-sustaining systems when the fuel cell is under load.

Some variations of the device comprise one or more replaceable fuel cartridges. This feature may be used for the convenience of resupplying an integrated fuel and fuel cell device with solid fuel. Another variation of the device involves “scaling” or utilizing one or more of the device components (e.g., the fuel cell component or fuel component) functionally to serve multiples of other components, for example by utilizing a single fuel source to provide hydrogen to multiple fuel cell components or by utilizing multiple fuel source components to serve one or more fuel cell components. Also included in this “scaling” variation is the placement of multiple fuel source-fuel cell combinations in parallel or series electrical configuration while optionally, cooperatively utilizing hydrogen produced by the various fuel sources or the water produced by the fuel cells. Such scaling may, for instance, be used to satisfy specific voltage or power requirements.

Another variation of the described device incorporates an activator for activating the solid fuel to initiate the device operation, which operation, as previously mentioned, may be otherwise self-sustaining under load.

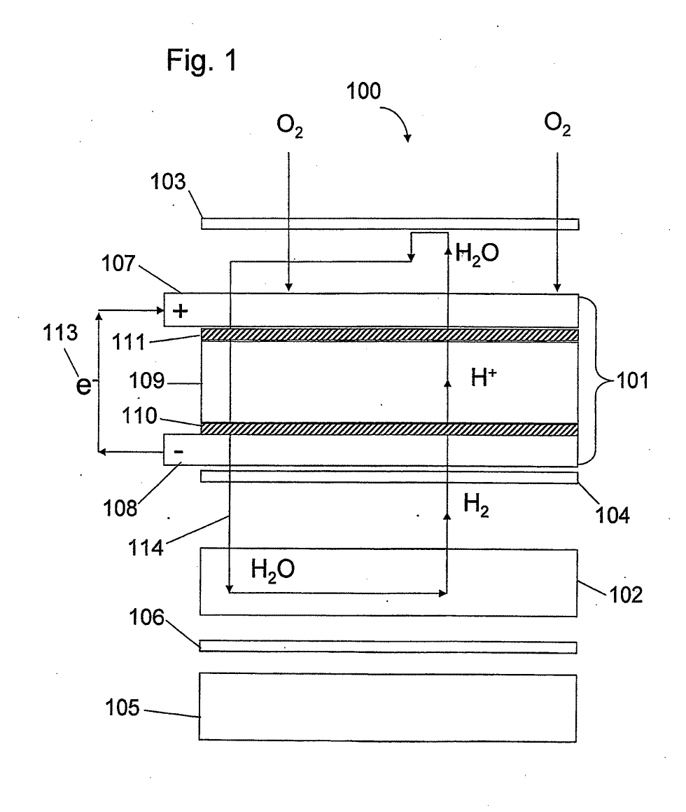

FIG. 1 provides a generic schematic of the overall device 100. The device comprises a fuel cell 101, a fuel source 102, and optionally, a water barrier 103, a water control system 104, an activator 105, and an activator barrier 106. It is important to note that these components are not limited to the configuration shown in FIG. 1 and may be configured in any way one sees fit to make the described device. The fuel cell 101 may be of a type that utilizes oxygen and hydrogen to produce an electrical current. As will be discussed below, there are a wide variety of fuel cell designs that utilize hydrogen and oxygen feeds to produce electrical energy. Consequently, the details of the fuel cell structure are important only to the degree that they otherwise cooperate with the fuel source 102 to produce electrical current.

The fuel source 102 includes materials that, when activated in some fashion such as by a chemical reaction with water or other suitable hydroxyl source, produce hydrogen. Although many of the variations described below involve a physical form of the included fuel that is, or could be understood to be, a substantially solid form, the physical form of the fuel source must only functionally be one that permits access by the activator and egress of the product hydrogen. The fuel may be in the form of a powder, granules, gel, or may constitute forms such as balls, cubes or the like. The fuel material may be mixed with stabilizers or catalysts, such as are discussed below. The fuel may be mixtures of materials, each hydrogen-producing in their own right or may be comprised of, consist of, or consist essentially of hydrogen producing compounds or material with or without the noted adjuvants.

An additional, but optional, component is barrier 103. The function of barrier 103 is to prevent the passage of reaction products, primarily water, from the fuel cell away from the described device and, in a more narrow sense, direct the passage of water back towards the solid fuel source 102. When being used to redirect water, barrier 103, should be preferentially comprised of a material or structure that is permeable to oxygen but not permeable to water. Materials having such properties include polytetrafluoroethylene (PTFE), polydimethylsiloxane (PDMS), polyolefins, porous metal films, and a large number of additional oxygen permeable hydrophobic materials. In some cases the barrier 103 may be completely or partially hydrophobic. In some case, the cathode may also act as a water barrier. In some cases the barrier 103 may not be desired such as when one unit of the device is being used as an activator for another unit of the described device. Such “daisy-chaining” may be used to functionally interconnect a plurality of the described devices in order to achieve the correct electronic architecture for the prescribed application.

In some variations of the described device, the hydrogen producing fuel source 102 is isolated from an activator 105 containing an activating agent. The activator permits the control of the time that the electrochemical reaction begins. This allows, for certain variations of the described device to be used after not being used for a significant period time. The activating agent may be a discrete source, and may be releasable upon a user's control or automatically upon the action of an alarm after the alarm detects an alarm condition. In some of the chemical reactions occurring in the fuel, the material comprising the activating agent, e.g., water, may be a product of the electrochemical reaction occurring in fuel cell 101. In such an instance, a continuous supply of reactant activating agent is not required in the fuel. Consequently, the activating agent may in such an instance be considered an initiator for the reaction in the overall operation of the described device. The location of the activator 105 and the activator barrier 106, relative to the fuel source 102, can be in any number of configurations, such as for example, situated below or on the side of the fuel source 102.

The activating agent need not, in all variations of this described device, be a discrete source. The activating agent may be incident water vapor as found in an adjacent atmosphere (e.g., room air), a cooperating chemical or mechanical process stream (e.g., a steam line or water line), or other source, optionally controllable by the designer of a specific device using the concepts described herein.

Generic structure for controlling the access the of the activating agent in the activator 105 to the fuel source 102 may be by the activation barrier 106. As discussed below the activation barrier 106 may be functionally of a wide variety of structures. When used, the function of the activation barrier is simply to substantially prevent access by the activating agent to the fuel source, whether that activating agent is situated in the activator or is somehow present in the environment. For instance, activation barrier 106 may be a member comprising a polymeric membrane. In some variations of the described device, such an activation barrier membrane would be configured in such a way that the membrane could be removed or torn to allow access by the activator to the fuel.

In some variations of the described device the barrier 106 comprising a membrane that is permeable to the activator may be used. In some variations, for instance, when the device is to be used in an environment otherwise containing gaseous components that should not enter the solid fuel source 102, the membrane may be of a type that permits passage of the activator but not passage of the other incident diluent gasses. That is to say that when a variation is configured to be placed in the open atmosphere containing water vapor, nitrogen, and oxygen, the membrane may be of a type that allows passage of water, as the activating agent, but not the passage of the gasses otherwise making up the air in that those gasses would either react with the hydrogen produced in the fuel pack or pass into the fuel cell itself, but in either case would hinder the efficient operation of the fuel cell.

The fuel cell 101 is comprised of components such as a first, or anode, current collector 108, and a second, or cathode, current collector 107, and a fuel cell membrane 109, which is permeable to protons or oxygen ions, but does not conduct electrons, and may be a polyperfluorosulfonic acid polymer membrane. Commercially available fuel cell membranes are available from, e.g., E.I. du Pont de Nemours and Co., in the NAFION line of polymers. Between anode current collector 108 and membrane 109 is a first, or anode, catalyst layer 110, and a second, or cathode, catalyst layer 111. A schematic load 113 completing a functional electrical circuit is shown between anode 108 and cathode 107. The catalyst layer is generally a carbon paper coated with catalyst such as Pt and Pd. The hydrogen from the solid fuel, diffusing to the anode of a fuel cell, and the oxygen supplied to the fuel cell cathode, generally from ambient air, react at the fuel cell to create an electrical current and water. The so-formed water, in turn, is shown to diffuse back into the solid fuel, where it reacts to form hydrogen, allowing the process of electricity production to proceed.

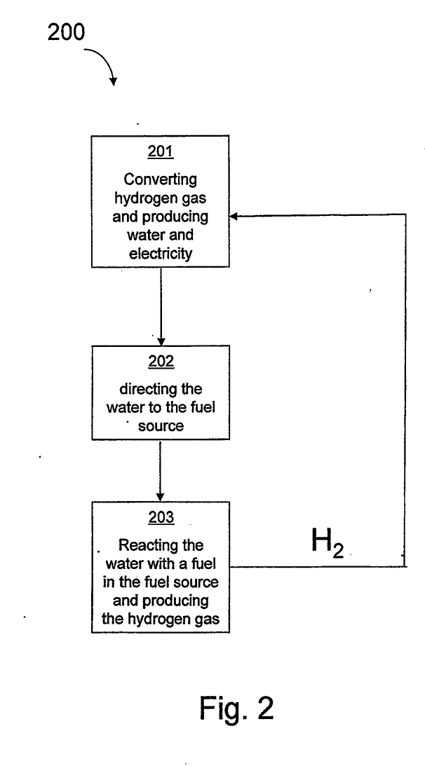

The redirection of the water by the combination of the water barrier 103, the catalyst layer 111 and the cathode current collector 107 to the fuel source is depicted by the closed control loop 114. This exemplary process is depicted in FIG. 2. In step 201 the water and electricity are generated by the fuel cell 101. In step 202 the water is redirected to the fuel source, the barrier 103 prevents the water from escaping the device, the remaining water will diffuse through fuel cell 101 and into the fuel source 102. In step 203 the water reacts with the fuel source 102 and produces hydrogen. The hydrogen then diffuses to the fuel cell 101 and is then used by the fuel cell 101 to create water and electricity and the cycle repeats itself until the fuel is consumed. The water that is redirected to the fuel source 102 may additionally pass through the water control system 104, which under certain condition may or may not allow water to pass to the fuel source.

In one embodiment the water control system 104 has a pressure sensitive switch that prevents water from entering the fuel source 102 and thus shuts down hydrogen generation when the device 100 is not a under load or requires low power output. The water control system is in general located between the fuel cell 101 and the fuel source 102. When the device is under a load the hydrogen is consumed by the fuel cell 101 and the pressure in the system P_{sys} remains below a critical pressure P_{c}. When the load is turned off or reduced less or no hydrogen will be consumed by the fuel cell 101 and the P_{sys} increases in response to the excess water in the system reacting with the fuel source 102 producing additional hydrogen. When the P_{sys} gets above P_{c} the pressure sensitive switch prevents the flow of additional water to the fuel source and thus shuts down hydrogen generation. When the load increases, the P_{sys} decreases due to hydrogen consumption by the fuel cell 101. When P_{sys} drops below P_{c} the pressure sensitive switch then allows water to flow to the fuel source 102 and hydrogen generations proceeds.

The water control system 104 controls the amount of water produced by the fuel cell 101 that goes to the fuel source 101. In some cases the water produced by the fuel cell may not be directed towards the fuel source 102. For example, if water barrier 103 redirects 100% of the water produced by the fuel cell, the fuel source 102 may become saturated with water. The water control system 104 would then direct some of the water away from the fuel source. The water control system can be configured to direct any fraction of the water produced by the fuel cell 101 away from the fuel source 102. Additionally the water control system can be configured to direct any fraction of the water produced by the fuel cell 101 to the fuel source 102. Additionally, the water control system can be configured such that the amount of water which is directed to the fuel source 102 is based on the rate of hydrogen production. This allows the device to be more responsive and improves the safety of the device. For example, initially 100% of water produced by the fuel cell may be directed to the fuel source 102 to ramp up H₂ generation and optimize the H₂ pressure within a safe operating limit of the device. Optimizing the hydrogen pressure enables the device to respond to spikes in energy demand. When the H₂ pressure is optimized the water may then be directed away from the fuel source 102. A number of different methods may be used to optimize hydrogen generation.

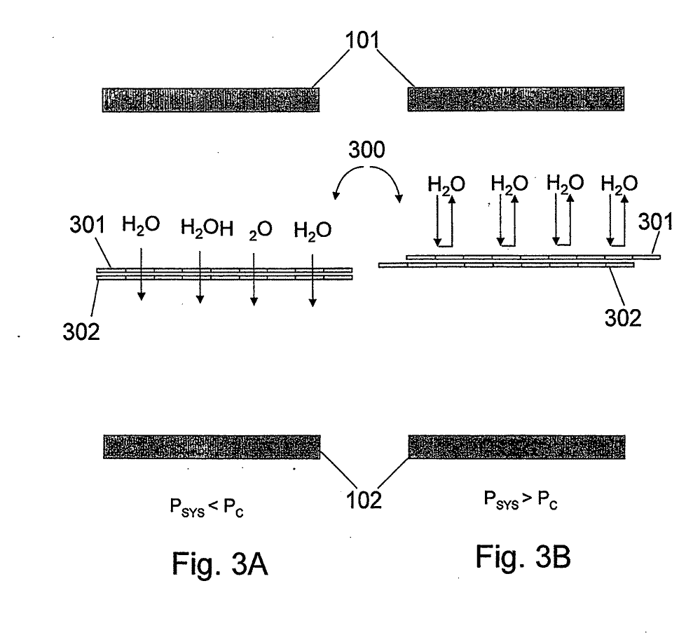

FIGS. 3A-3B depict a water control system 300. In this example the water control system 300 contains a pressure sensitive mechanical switch 301/302 that changes its configuration as the pressure in the system P_{sys} increases. The water control system 300 is located between the fuel cell 101 and the fuel source 102. The water control system is encased in a housing (not shown) which prevents water from penetrating through to the fuel cell except through a channel created by the water control system 300. The mechanical switch is composed of two layers of material 301 and 302, wherein each of the layers contains regions through which H₂O can and can not pass. These regions may be gaps in the material which when aligned correctly allow H₂O to pass. Under constant load conditions (P_{sys}<P_{c}) the regions through which H₂O can pass are aligned as shown in FIG. 3A. Under no load conditions (P_{sys}>P_{c}), one of the layers 301 is forced to change positions and align with the other layer 302, such that H₂O can no longer pass through the layers, thus shutting down hydrogen generation. Water will then be redirected to a storage container (not shown) or allowed to evaporate into the atmosphere. H₂O. The pressure sensitive mechanical switch 301/302 may be replaced with a pressure sensitive mechanical regulator which is analogue in nature, such that the pressure in the system controls the amount of water which passes through the water control system 300.

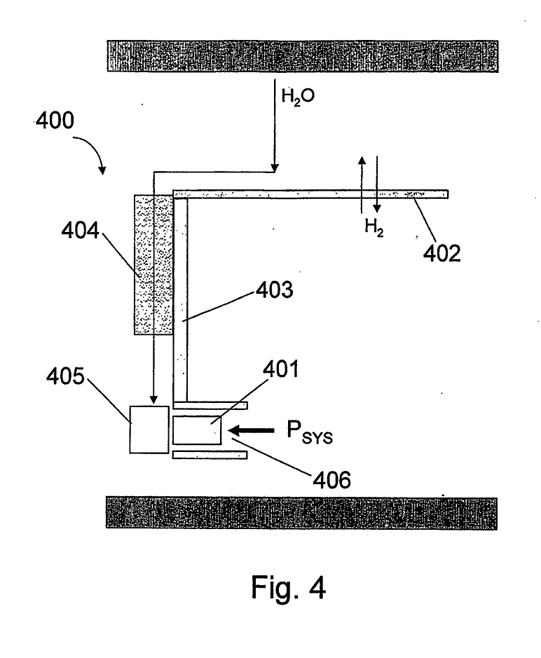

FIG. 4 is a schematic depiction of another mechanical water control system 400 comprising a mechanical switch 401. The water control system 400 is additionally comprised of a water impermeable layer 402, such as PTFE, which allows hydrogen generated in the fuel source 102 to pass to the fuel cell 101; a housing 403 partially shown), which encases the water control system and otherwise prevents water from penetrating through to the fuel source 102 except through a channel opening 406 controlled by the pressure sensitive mechanical switch 401; and optionally a condenser 404 for condensing the water produced by the fuel cell to a water storage region 405. The water storage region 405 may be a container for storing the water and may contain a foam material such as a hydrogel which absorbs the water. The water control system 400 may contain tubing or channels (not shown) which direct the water produced by the fuel cell to the water storage region 405. As discussed above, when the device is under load, P_{sys} is less than P_{c}, and thus the water control system 400 allows the passage of water to the fuel source 102. When the device is no longer under load P_{sys} increases. When P_{sys} becomes greater than P_{c} the water control system 400 prevents the water from entering the fuel source 102, thus shutting down hydrogen generation. The pressure sensitive mechanical switch 401 may be replaced with a pressure sensitive mechanical regulator which is analogue in nature, such that the pressure in the system controls the amount of water which passes through the water control system 400.

With respect to FIGS. 3 and 4, a material (not shown) such as a polymer, which has altering gas flow properties under different pressures, can replace the pressure sensitive mechanical switch/regulator and act as a pressure sensitive chemical switch/regulator. When P_{sys} is less than P_{c} the material allows the passage of water, but when P_{sys} is greater than P_{c} the flow properties of the material changes and prevents the passage of water. Materials having such properties include soft materials containing micro-channels or holes which are designed such that the size of the microchannels is sensitive to the pressure, such as for example, polymers such as, nylon, poly 2-(acrylamindo)-2-methylpropanesulfonic acid (PAMPS). Optionally, these materials may be connected to a electrical control system which applies a voltage to the material causing the material to constrict or expand to prevent the passage of water or allow the passage of water, depending on the configuration and depending on the pressure in the system.

Additionally the mechanical/chemical switch or regulator discussed above may be sensitive to a third pressure P_{L} which is the pressure at which the switch or regulator allows the passage of water to fuel source after the passage of water has been shut down. For example when the system is under no or very little load and when (P_{sys}>P_{c}) both the switch and regulator shut down the passage of water to the fuel source. When a load is present the switch or regulator continues to prevent the passage of water until Pₛ is at or less than P_{L}, which is less than P_{c}. Introduction of sensitivity to P_{L} allows for smoother control of the passage of water through the water control system.

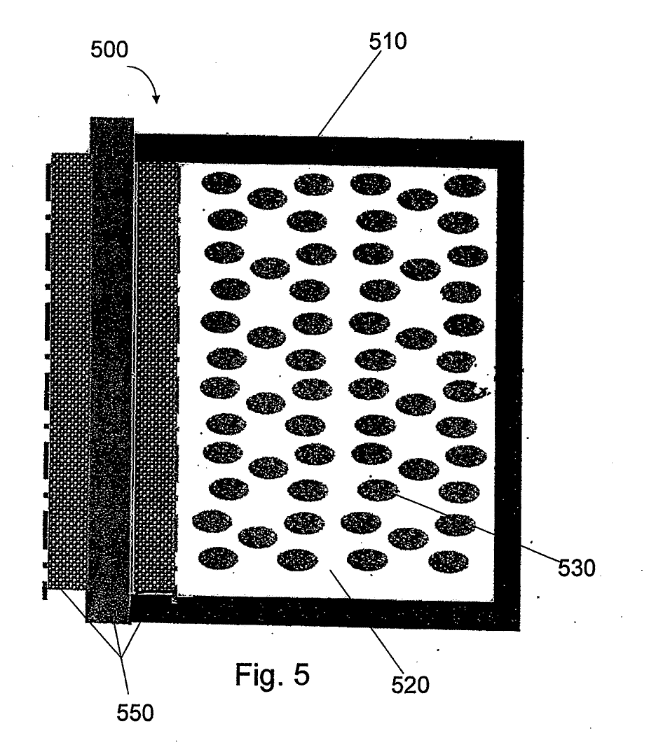

FIG. 5 displays one variation of the described device, in this instance, an integrated fuel and fuel cell device 500. The device is encased in a housing 510 adapted to accept a fuel cell 550. The housing 510 encloses a chamber 520 that, in turn, includes solid fuel 530. Various generic and specific classes of solid fuels appropriate for use as fuel 530 are discussed below. The fuel itself, as situated in chamber 520 and thereby forming a fuel source, may be in any appropriate physical form permitting passage of the produced hydrogen to the fuel cell 550 and desirably allowing water produced during fuel cell operation to pass back to the fuel source. The housing 530 may be used, when present, to aid in interaction between the fuel cell and the fuel source, so that hydrogen produced by the solid fuel is readily available to the fuel cell and the water produced by the fuel cell is readily available to the solid fuel.

As is the case with many of the depictions in this description, certain components that might be desirable or even necessary for the practical operation of the described device in a specific environment, are not shown in the various drawings for the specific purpose of allowing a clear description of the components that are shown Any so-omitted components are of a type or function such that one of ordinary skill in the art would recognize the need for such components and include them during the ordinary course of device design. For instance FIG. 5 does not show the presence of a housing or a conduit for directing oxygen to the appropriate side of the fuel cell 550. In an instance where a designer proposed a design using the teachings contained here and included a specific oxygen source, e.g., a chemical source, and wished to direct that enhanced oxygen source to the fuel cell 550, the designer would include such a housing or conduit.

Fuel cells that may be used as components of the described device may be those described elsewhere, some of which are readily commercially available. The system can be designed to accommodate and fuel cell which combines H₂ and O₂ to produce H₂O. Examples of such fuel cell designs include the proton exchange membrane fuel cell (PEMFC), the alkaline fuel cell (AFC) and Solid Oxide Fuel Cell (SOFC). For PEMFCs and SOFC, the operative half reactions are given in Equation 1:

$$\frac{\begin{matrix}Anode \text{:} 2 {H}_{2} 4 {H}^{+} + 4 {e}^{-} \\ Cathode \text{:} 4 {e}^{-} + {O}_{2} + 4 {H}^{+} 2 {H}_{2} O\end{matrix}}{Net \text{:} 2 {H}_{2} + {O}_{2} 2 {H}_{2} O + Heat} \qquad Equation 1$$

while the operative half reactions for AFCs is given in Equation 2:

$$\frac{\begin{matrix}Anode \text{:} 2 {H}_{2} + 4 O {H}^{-} 4 {H}_{2} O + 4 {e}^{-} \\ Cathode \text{:} 4 {e}^{-} + {O}_{2} + 2 {H}_{2} O 4 O {H}^{-}\end{matrix}}{Net \text{:} 2 {H}_{2} + {O}_{2} 2 {H}_{2} O + Heat} \qquad Equation 2$$

As may be seen from Equation 1, chemical reactants for PEMFCs and SOFCs include hydrogen, and oxygen; while for the AFCs, as given in Equation 2, the reactants are hydrogen, hydroxide ions, oxygen, and water. It should also be noted that the net reaction is the same for both types of cells, so that in addition to producing electricity, water and heat are additionally produced. Many commercially available fuel cell assemblies utilizing conventional PEMFC, SOFC, and AFC fuel cells use atmospheric oxygen as a reactant. Those assemblies also typically use hydrogen from an external source, such as a hydrogen storage tank or a hydrogen generator.

As previously mentioned, several types of solid fuels are suitable as at least a portion of the fuel source in the described device. For instance, members of the alkali metal group of the Mendeleyev Chart, such as sodium, and various other metals, such as aluminum and magnesium, readily react with water in alkaline solution to produce hydrogen gas. An example of a balanced equation for the generation of hydrogen from aluminum is given as:

Al+NaOH+H₂O→NaAlO₂+1.5H₂↑+Heat

Additionally, hydride salts of metals, alkali metals, and alkaline earth metals, and complex salts of metals, alkali metals, and alkaline earth metals, react with water to produce hydrogen. An example of a balanced equation for the reaction of a metal hydride with water to produce hydrogen is given as:

MgH₄+2H₂O═Mg(OH)₂+3H₂↑+Heat

Still another class of solid fuels comprises borohydride salts of alkali metals, alkali earth metals, ammonium, and alkyl ammonium and complex salts thereof. One such member is sodium borohydride. A balanced equation for the generation of hydrogen from sodium borohydride is given as:

NaBH₄+2H₂O→NaBO₂+4H₂↑+Heat

In the reactions described above directing the H₂O produced by the fuel cell to the solid fuel source increases the amount of H₂ produced by the total mass of NaBH₄ and H₂O. In the case when the water for the above reactions is obtained from an external source, the total mass of the solid fuel and the external water is larger than the total mass of the solid fuel plus directed water, because the directed water is being recycled. When water produced by the fuel cell is not directed to the solid fuel source, the amount of H₂ produced by the above reactions is 1, 2, and 2 from the solid fuel and the remaining H₂ comes from the external water molecules. If the water which reacts with the solid fuel source is water which is produced by the fuel cell then the apparent amount of H₂ produced by the solid fuel for the above reactions is 1.5, 3, and 4 because the water produced from the fuel cell was made using hydrogen generated by the solid fuel. Thus, the recycling of the hydrogen produced by the solid fuel in the form of water produced by the fuel cell increases the amount of H₂ produced by the solid fuel relative to the total mass of solid fuel and water. Thus, for the case of NaBH₄, directing the water produced by the fuel cell doubles the apparent amount of hydrogen produced per NaBH₄ molecule.

In addition to sodium, other alkali metals suitable as hydrogen-generating fuels include lithium, potassium, and rubidium. Other metals in addition to aluminum suitable for use in hydrogen-generating fuels include magnesium and zinc. Exemplary candidates from the group of hydride salts of metals, alkali metals, and alkaline earth metals, and complex salts thereof. Additional fuels include NaAlH₄, LiAlH₄, KAlH₄, NaGaH₄, LiGaH₄, KGaH₄, Mg(AlH₄)₂, 2Li₃AlH₆, Na₃AlH₆, and Mg₂NiH₄, and their mixtures. Finally, in addition to sodium borohydride, other suitable borohydride salts of alkali metals, alkali earth metals, ammonium, and alkyl ammonium and complex salts thereof include LiBH₄, KBH₄, Mg(BH₄)₂, Ca(BH₄)₂, NH₄BH₄, and (CH₃)₄NH₄BH₄, and their mixtures.

Additionally, the hydrogen-producing solid fuel may further comprise catalysts or catalyst precursors, as desired, in the described device. Materials that are useful as these optional catalysts include transition metals, transition metal borides, and alloys and mixtures of these materials. Suitable transition metal catalysts are listed in U.S. Pat. No. 5,804,329, to Amendola, the entirety of which is incorporated herein by reference. Catalysts containing Group IB to Group VIIIB metals, such as transition metals of the copper group, zinc group, scandium group, titanium group, vanadium group, chromium group, manganese group, iron group, cobalt group, and nickel group are suitable in various configurations. Such catalysts lower the activation energy of the reaction of borohydrides with water to produce hydrogen. Specific examples of suitable transition metal elements include ruthenium, iron, cobalt, nickel, copper, manganese, rhodium, rhenium, platinum, palladium, chromium, silver, osmium, iridium, their compounds, their alloys, and their mixtures. In some embodiments the catalyst may comprise about 1 wt %-10 wt % of the fuel mixture. The catalyst is used to enhance the activation of the reaction of the solid fuel with water to produce hydrogen.

According to the reaction NaBH₄+2H₂O→NaBO₂+4H₂ the byproduct NaBO₂ is alkaline. Stabilizers which will increase the alkalinity of NaBH₄ and by product NaBO₂ will stabilize the NaBH₄. These stabilizers include metal hydroxides such as NaOH, KOH, etc.

In general, the attributes of fuels that may be considered in selecting a specific fuel composition include such parameters as energy density (often measured in watt-hours per unit mass), ease of activation, stability, availability, and cost. The “ideal” fuel would have a high energy density and good storage and use stability under a variety of conditions in the device. This “ideal” fuel composition would be readily activated under ambient conditions and be readily available at reasonable cost. Many of the neat compounds and compositions specified above have suitable values of these attributes and are appropriate for use in my device.

Additionally, as mentioned elsewhere herein, the various solid fuel compositions may be situated in the fuel source 102 in a variety of forms including blocks (perhaps porous), powders, pastes, gels, pellets, granules, shaped forms made for a specific purpose (e.g., such as enhancing diffusion to a maximum volume of fuel), balls, and the like. Certain slurries, dispersions of solid fuels, and liquid-containing solid fuel compositions (in which the liquid is not water or other activator for the solid fuel) may also be used, if so desired. The liquids in the latter compositions may be highly oleophilic and hence non-reactive with the solid fuel compositions. These liquids allow formation of globular concentrations of water that pass to the solid fuel particles.

The composition of the fuel source may comprise mixtures not only of one or more members of a single class of compounds, e.g., the borohydrides or the hydrides, the composition may comprise mixtures of members from different classes of compounds, e.g., two or more members from the classes of borohydrides and hydrides and metals. Such mixtures may be employed as the fuel composition for a variety of reasons. Mixtures may be employed to minimize cost, to increase or to slow the rate of reaction “light-off,” to improve or to specify an overall specific fuel energy density, to meet weight considerations for a specific design, and to meet other design criteria.

As an example, mixtures of fuels may be used to meet energy density criteria. The energy density, expressed as watt-hour/unit mass of fuel varies for different solid fuel sources, as does the molecular weight of the material. As a comparison, a mixture of 1 mol of aluminum (27 grams), 1 mol of sodium hydroxide (40 gram), and 1 mol of water will produce 33.6 liters of hydrogen gas. If this volume of hydrogen is consumed by a fuel cell producing a voltage of 0.6 V, 64 watt-hours of electricity will be produced. A fuel of 1 mol of magnesium hydride (28.3 grams) reacted with 2 mols of water will produce 67.2 liters of hydrogen. The magnesium hydride fuel results in 128 watt-hours of electricity when consumed by a fuel cell producing at 0.6 V. Still another example: 1 mol of sodium borohydride (37.8 gram) and 2 mols of water will produce 89.6 liters of hydrogen gas, and, if consumed by a fuel cell at 0.6 V, that fuel cell will produce 170 watt-hours of electricity. Based upon the weight of the fuel, the energy density of aluminum is 2.4 watt-hours/gm, the energy density of magnesium hydride is 4.5 watt-hours/gram, and the energy density of sodium borohydride is 4.5 watt-hours/gram.

A fuel composition comprising 1 mol of aluminum (27 grams), 1 mol of sodium borohydride (37.8 gram), and μmol of sodium hydroxide (40 gram) produces 123 liters of hydrogen gas. Such an amount of hydrogen consumed in a fuel cell at 0.6V will produce 233 watt-hours of electricity. The overall energy density of the fuel composition is 3.6 watt-hours/gram. Although the energy density of aluminum is not as high as that of sodium borohydride, it is readily available, and the composition including sodium hydroxide enhances the stability of the borohydride salt. This fuel composition has a substantial energy density and carries with it a cost that is lower than a fuel composition made up solely of the comparatively more expensive borohydride salt.

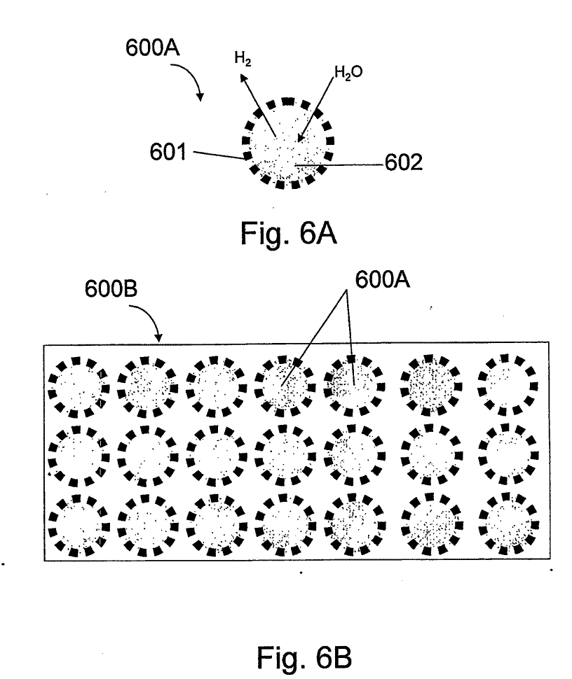

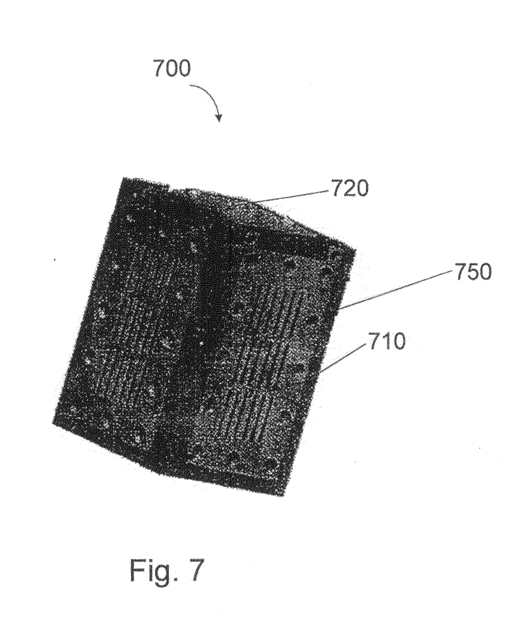

In one embodiment the fuel within the fuel source 102 (FIG. 1) may be contained in individual capsules as depicted in FIGS. 6A-6B. FIG. 6A depicts one individual capsule 600A containing the solid fuel. The capsule has a porous structure 601 and encases the fuel in the interior 602 of the capsule. The capsules are made from a material which allows water from outside the capsule to enter the interior of the capsule 602 and react with the fuel and allows hydrogen produced in the reaction to leave the capsule. Materials such as a micorporous stainless steel mesh or certain polymeric or plastic materials can be used to make the capsules such as polystyrene (EPS), PTFE, carbon, metal or alloy powder, polyurethane etc. The individual capsules can then be packed into the housing 600B which contains the individual capsules 600A. The capsule should be configured to account for fuels in which the reaction product has a greater volume than the fuel, such as for example NaBH₄ →NaBO₂, in which the volume of NaBO₂ is greater than NaBH₄. For examples the capsules may contain a void when the fuel is present to account for the larger volume of the byproduct. Additionally, the capsules may be made from a material which can expand as the volume of the material inside the capsule increases. Containing the fuel in capsules offers the advantage of increasing the water accessible surface area of the fuel. The capsules may also be designed to offer water control properties, similar to the water control system described above, in which the surface of the capsule or the capsule is made from a material which is sensitive to the pressure in the system, thus preventing water from reacting with the fuel when P_{sys} is greater than P_{c}, such as for example, poly [2-(acrylamindo)-2-methylpropanesulfonic (PAMPS), PTFE powder plus PAMPS or metal plus PAMPS.

Additionally one of the capsules may act as an activating capsule to act as activator to start the hydrogen generation from the fuel. In this case, the mentioned one capsule may contain water or H₂. The water or H₂ contained by that capsule may be initially reacted with the fuel or the fuel cell and respectively produce hydrogen for the fuel cell or water for the fuel.

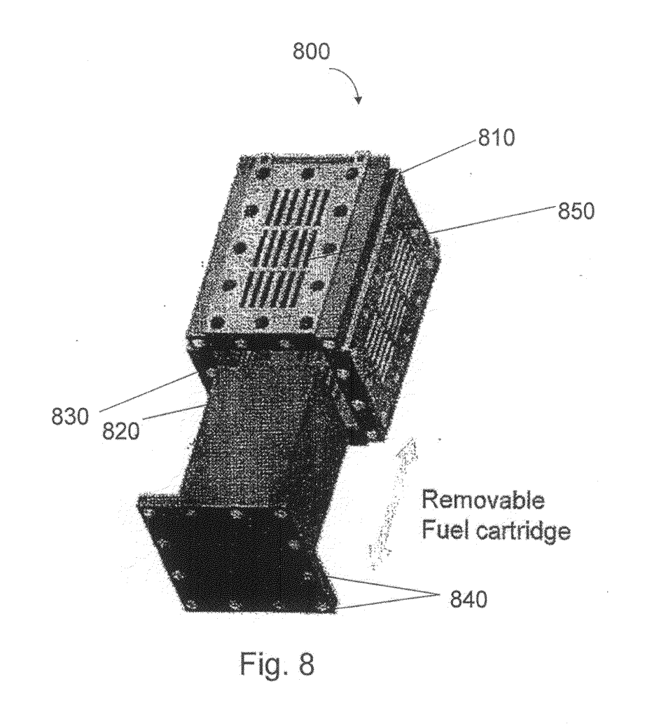

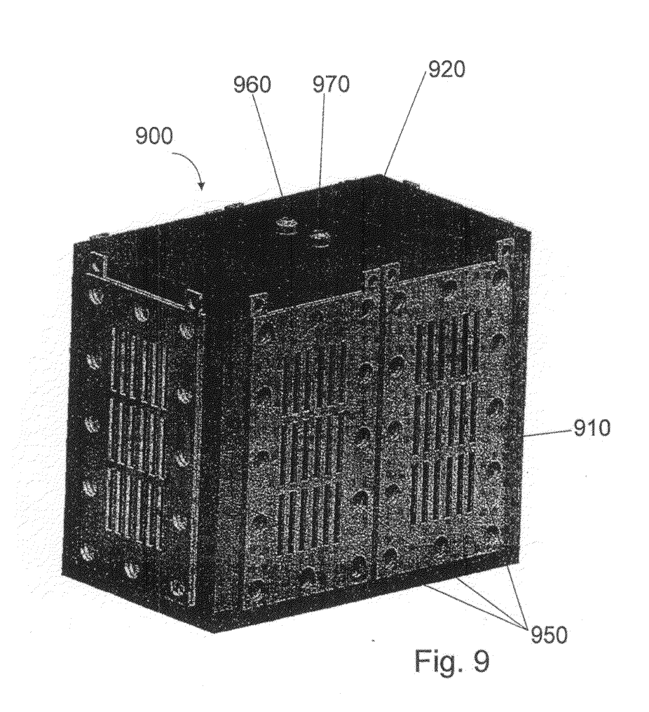

FIGS. 7, 8, and 9 show three dimensional representations of other variations of the device 700, 800, and 900. In FIG. 7, a front view of the device shows a housing 710 configured to accept four fuel cells 750, one on each side of housing 710. Generally centered in the housing 710 is a fuel source 720 (more clearly seen in FIG. 8), that serves each of the integrated fuel cells 750 with hydrogen.

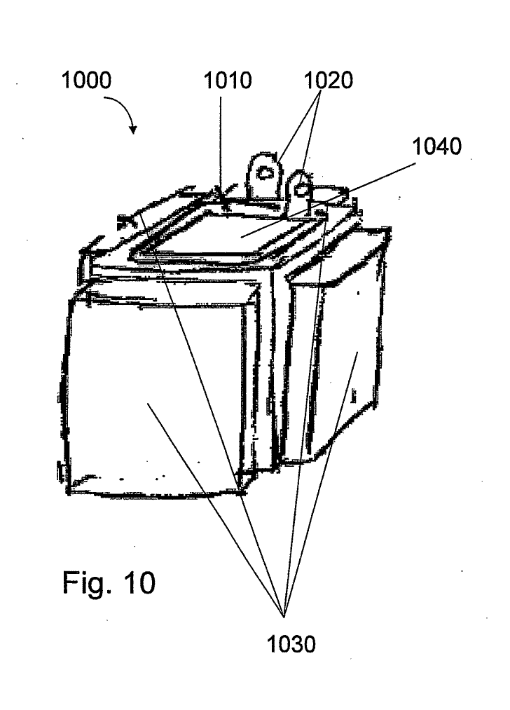

FIG. 9 shows a perspective view of a variation of the described device, in this instance an integrated fuel source and fuel cell device 900 having a housing 910 and six fuel cells 950 (three are shown). A single fuel source 920 is situated centrally to the six fuel cells 950 for supplying hydrogen to each. Water sources 960, 970 are also shown.

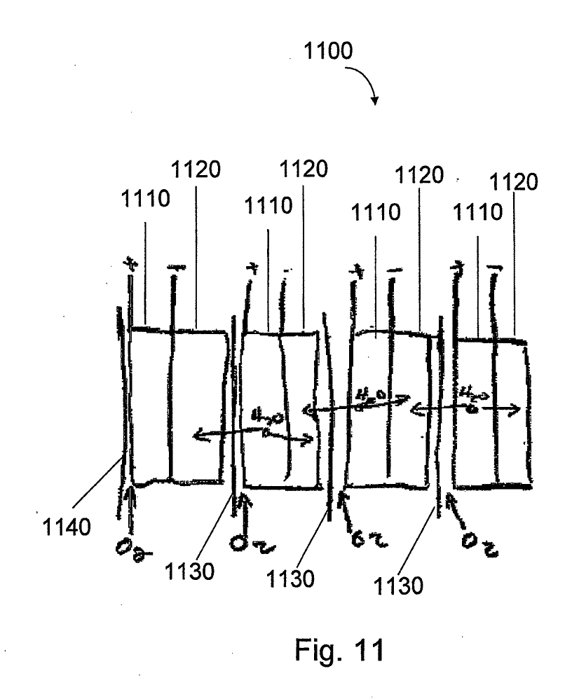

FIG. 10 shows a variation of the described device 1000 having a single fuel cell component 1010 with electrical connections 1020 to the cathode and anode. The central area of the fuel cell component 1040 is hollow to allow access of reactant oxygen to the cell. Multiple fuel sources 1030 are situated around the periphery of the fuel cell 1010 demonstrating the scalability of the device.

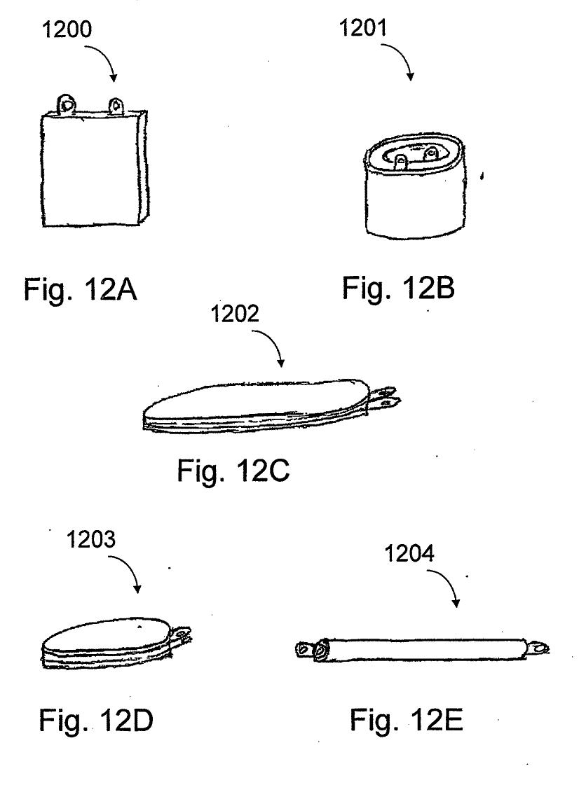

FIG. 11 shows a variation 1100 of the device in which a series of fuel cell 1110 fuel source 1120 combinations are separated by polymeric membranes 1130 that selectively allow water to pass but not gas. The water produced at the fuel cell may pass from one cell to another thereby activating a series of fuel cells. Optionally, the layer 1140 (103, FIG. 1) which allows oxygen to flow into the device but does not allow water to escape the device is present.

Using as an example a component fuel cell operating at a 0.6V potential and using the variations of the integrated fuel and fuel cell devices seen as (100), (700), and (900) in FIGS. 1, 7, and 9, the depicted devices would respectively provide 0.6V, 2.4V—four fuel cell components, and 3.6V—six fuel cell components. Regarding scalability in general, though examples of integrated fuel and fuel cell devices having one, four, and six fuel cell components have been shown, there is no theoretical limit for this scalability variation of the described, integrated fuel source and fuel cell device.

FIG. 8 shows a perspective view of the integrated device with the included fuel cartridge 820 extending from a cooperative hollow 820 in housing 810. The fuel cartridge 820 is removable once the depicted fasteners 840 are removed. Of course, any of the variations of the integrated fuel and fuel cell devices described herein, such as 100 (FIG. 1), and 700, 900 (FIGS. 7, and 9) may comprise a fixed chamber containing fuel or adapted to contain solid fuel, or with a removable or replaceable fuel cartridge containing solid fuel. In any event, removable fuel cartridges, such as fuel cartridge 720, 920 shown in FIGS. 7 and 9, may be used to re-supply fuel to any of the variations described herein. Alternatively variations of the subject device may be fabricated to be disposable and having a finite usage like a conventional disposable chemical battery.

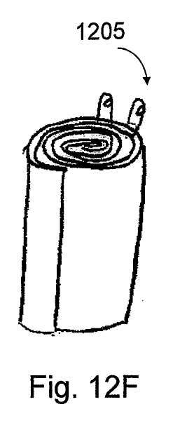

Although the devices 100 (FIG. 1), and 700, 800, 900 (FIGS. 7, 8, and 9), are shown to be generally flat-sided or having a cubic or brick-like configuration, the aspect ratio of such shapes may be considerably varied resulting, for instance, in a device that is card-shaped 1200 (FIG. 12A). Other suitable device shape configurations include cylinders 1201 (FIG. 12B), where the fuel cell anode and cathode are cylindrical, disks 1202 (FIG. 12C), where the fuel cell anode and cathode are substantially flat, ellipses 1203 (FIG. 12D), where the fuel cell anode and cathode are substantially flat, rods, 1204 (FIG. 12E), where the fuel cell anode and cathode are cylindrical and the fuel source is exterior to the fuel cell component, and other specially designed shapes. FIG. 12F shows a device configuration 1205 employing a spiral shaped fuel cell and fuel source suitable for higher current flows for a fairly short time. The very high surface area of the fuel cell membrane and the relatively low ratio of fuel volume to fuel cell area provides for this selection of operating parameters.

As previously mentioned, some variations of the device are self-sustaining under load. The dynamics of the integrated fuel source and fuel cell devices may be given by the following example of a device using sodium borohydride, integrated with a fuel cell:

Fuel: NaBH₄+2H₂O→NaBO₂+4H₂↑+Heat

Fuel cell (net): 4H₂+2O₂→4H₂O+Heat

In this case, 1 mol NaBH₄ produces 4 moles of hydrogen gas, 2 of which come from the water produced by fuel cell. The water produced by fuel cell is not generally taken into account when calculating the energy density, which is measured in terms of watt-hours per unit volume or watt-hours per unit mass of the device. Thus, the feedback of water increases the energy that can be extracted from the total mass of NaBH₄ and water.

It should be appreciated that once the reaction in the solid fuel is initiated by introduction of water, and while the fuel cell is under load, the overall reaction is self-sustaining for so long as the fuel cell reaction produces water that is directed back to the fuel source. Again, when hydrogen from the solid fuel is readily available to the fuel cell for producing electricity, and the water produced by the fuel cell is readily available to react with the solid fuel creating a continual supply of hydrogen fuel for the fuel cell, the overall reaction in the device is self-sustaining. Specific designs for integrated fuel and fuel cell devices that introduce an initial amount of reactant activator or, in this instance, reactive water, are discussed below. This initial introduction may be considered “priming” the reaction or “activating” the reaction or the device. Indeed, in some variations of the described device, the device may comprise a discrete source of such an activator material. The activating source may be liquid or vapor. Indeed, for water, a water vapor source may be an environmental constituent. Of course, the activation may take place with water or water vapor from a source other than the fuel cell, either initially, or when the device is under intermittent load.

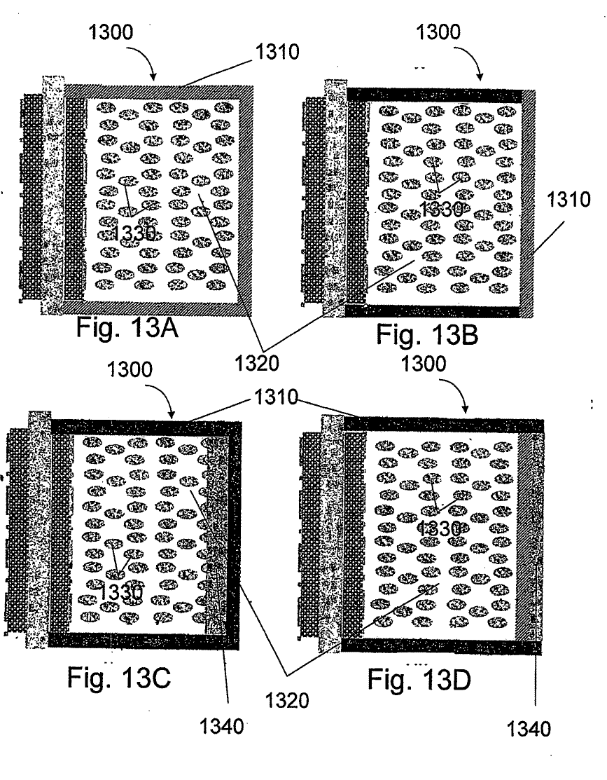

FIGS. 13A-13D show several designs for structures that provide for activating of the reaction in the fuel source wherein water or water vapor, from a source other than the fuel cell, may contact the solid fuel 1330. In general, the device may include structures and materials where water to the solid fuel is carried through openings, such as pores, ports, or channels, where the flux is controlled by: 1.) The thickness of the material determines the effective flow path length, wherein a longer path length is correlated with a decreasing flux.

2.) The shape of the pores, ports, or channels, so that a more irregular shape creates a more tortuous path, and decreases the flux. 3.) The size of the pores, ports, or channels, so that a larger the cross-sectional area increases the flux. 4.) The number of pores, ports, or channels, so that a greater number of openings increases the flux. In addition to physically controlling the flux, control of the openings may be affected by mechanical control, such as a shutter, stop or the like.

FIGS. 13A-13B, in some variations of the device, the entire housing 1310 (FIG. 13A), or a portion of the housing (FIG. 13B) comprises a membrane material that permits externally applied liquid water or water vapor (e.g., from the atmosphere or from a person's breath) to pass or to diffuse into the fuel chamber 1320, while barring the passage of gases. Examples of such membranes include members of the ionomer class of membrane materials. Such membranes have hygroscopic functional groups immobilized within their polymeric structure that are very efficient in absorbing water. These membranes further have interconnections amongst the functional groups causing very rapid transfer of water through the membrane material. Examples of the type of polymer used for ionomer matrix include various fluorocarbons, ethylene-styrene interpolymers, polybenzimidazole, and various polyaryletherketones. In other variations of the integrated fuel and fuel cell device shown in FIGS. 13A-13B, the housing 1310 may have ports or channels, perhaps mechanically controllable in size, situated in the housing wall or used instead of the housing wall. In other variations of the device, ports or channels in the housing material are used in conjunction with a membrane material.

In still other variations of the subject integrated fuel and fuel cell device, shown in FIGS. 13C-13D, the device includes a water source, e.g., one or more compartments or reservoirs 1340 capable of holding water. FIG. 13C shows a device having a reservoir or compartment 1340 within the housing 1310. FIG. 13D shows a device in which the water source comprises a compartment or reservoir which may be external to housing 1310 but still allows water to pass to the solid fuel 1330 as will be explained in more detail later. The reservoir or compartment 1340 allows water to pass to the solid fuel 1330 within the device, where the water flux may be controlled by the size of the reservoir and the amount of water therein, and the permeability of the reservoir or compartment to water. Such a reservoir or compartment may control the flux of water by including openings, such as ports or channels allowing water or water vapor to pass to solid fuel 340. Alternatively, compartment or reservoir 1340 may include a permeable barrier, perhaps a semipermeable membrane material as previously described, situated between the water source and the fuel to allow the water or water vapor to pass into chamber 1320 having solid fuel 1330 therein (FIG. 15D).

Still other variations of the device 1300 having a water source 1340, may include a combination of the controllable opening features of the devices shown in FIGS. 13C and 13D. The openings may be mechanically controllable in size or in controlling the rate of water flux into the chamber 1320 and may be used in conjunction with a membrane material (see e.g. FIG. 1 106) to control the overall rate of water or water vapor passage into solid fuel 1330.

Another variation of the combination the fuel source and fuel cell device comprises a hydrogen source exterior to the device configured to pass hydrogen to the fuel cell or cells and to generate electricity and subsequent water generation. The resulting water, passed to the fuel source, initiates or primes the hydrogen-producing reaction in the fuel.

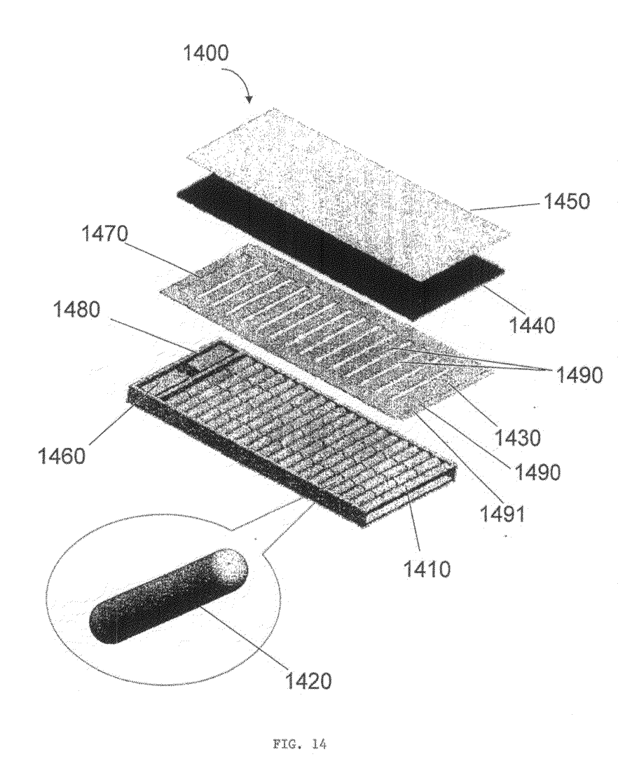

FIG. 14 is a schematic of a device 1400 containing a fuel source 1410, a water control system 1430, a fuel cell 1440 and a water barrier 1450. The fuel source 1410 contains the solid fuel in individual capsules 1420. The water control system 1430 is comprised of two layers of material (1490/1491) wherein each of the materials have control gaps 1490 which when aligned correctly can allow the passage of water through the water control system and a storage gap 1470 which is open when the control gaps 1490 are closed. The storage gap allows the passage of water to a storage container 1480 when the control gaps 1490 are closed. The alignment of the gaps may be controlled by the pressure in the system. Additionally the device may have electronic components 1480 for controlling the electrical output of the device, such as for example a voltage converter.

Various fuel source and fuel cell device are explained in the following Examples.

### Example 1

An integrated fuel and fuel cell prototype device having a single fuel cell was constructed and tested. A fuel cell rated at 0.6V, obtained from Heliocentris Energie System GmbH (65×65×25 mm), was mounted on a housing made of machineable acrylic sheet. The dimensions of the integrated fuel and fuel cell prototype device were 65×65×85 mm. The fuel cell chamber was filled with 5 grams of NaBH₄ powder and 0.01 g of a cobalt metal powder. Both materials were obtained from Alfa Chemical Corporation. The device included a 20 ml water reservoir separated from the solid fuel by an anionic membrane made by Sybron Chemicals. For this Example, the water reservoir was charged with 10 ml of water. An amount of at least about 500 μl water would be theoretically sufficient for initiating operation. The fuel cell open circuit potential was measured at 0.85 V. A small motorized fan was connected to the fuel cell. Under that load, the voltage was measured to be 0.6 V. In the first test of the device, the fan was allowed to run for 3 hours continuously before being disconnected.

### Example 2

In example 2, a variation of the device described in Example 1 was made having a double membrane thickness, so that the water permeability varied from Example 1 and the water flux rate was reduced by 50% from that in Example 1. In this Example, the anion membrane material used in Example 1 was reinforced with a Nafion® membrane covering. The fuel cell open circuit potential was measured at 0.83 V. The motorized fan used in Example 1 was connected to the fuel cell, and under load the fuel cell voltage was measured at 0.6V. The fan was run continuously for 4 hours before being disconnected, and the integrated fuel and fuel cell device was shelved for 2 months. After the 2 month period, the fan was reconnected to the integrated fuel and fuel cell device, and run continuously for 25 hours before being disconnected.

### Example 3

In example 3, a device similar to that shown in FIG. 7 was made and tested. Four cells each rated at 0.6V, obtained from Heliocentris Energie System GmbH (65×65×25 mm), were mounted on a housing made of machinable acrylic sheet. The dimensions of the prototype device are 105×105×80 mm. A removable cartridge was made having a fuel chamber surrounding a cavity in the center of the cartridge. A fuel charge comprising 100 g of NaBH₄ powder and 0.2 g of cobalt powder catalyst was placed in the periphery of the cartridge. A water reservoir having a capacity of about 30 ml was situated within the top of the housing, positioned above the fuel cartridge. The water reservoir was designed to have cylindrical hollow rods filled with Nafion tubing obtained from PermaPure LLC, joined to openings in the reservoir, and projecting into the cavity of the fuel cartridge. Water permeated into the fuel chamber from the 5 cylindrical hollow rods filled with Nafion tubes. The open circuit voltage of the prototype device was measured at 3.0 V. A fan was connected to prototype device and allowed to run continuously for over a day before the fan was disconnected. The measured potential under load was 2.4V.

### Example 4

In example 4, a device similar to that shown in FIG. 7 was made and tested. Four cells each rated at 0.6V, obtained from China Sunrise fuel cell Company (40×70×2 mm), were mounted on a rapid prototyping case. The cathode side of the fuel cell was coated with twice the amount of PTFE (20 wt %) than anode side (10 wt %) in order to redirect the water back to the fuel. The dimensions of the prototype device are 44×44×80 mm. A removable cartridge was made having a fuel chamber surrounding a cavity in the center of the cartridge. A fuel charge comprising 5 g of NaBH₄ powder and 0.5 g of cobalt powder catalyst was placed in the periphery of the cartridge. A water reservoir having a capacity of about 10 ml was situated within the top of the rapid prototyping case, positioned above the fuel cartridge. The water reservoir was designed to fill with 24 inch Nafion tubing obtained from PermaPure LLC, joined to openings in the reservoir, and projecting around the cavity of the fuel cartridge. Water permeated into the fuel chamber from the Nafion tubes. The open circuit voltage of the prototype device was measured at 3.4 V. A 20 mA of current was loaded to prototype device and allowed to run continuously until the fuel was used up. About 9 watt-hour electricity was obtained

### Example 5

Example 5, is the same device as described in example 4 except that a porous PTFE membrane obtained from Electric-fuel, com was put on the surface of cathode current collector. The open circuit voltage of the prototype device was measured at 3.4 V.

### Example 6

Example 5, is the same device as described in example 4 except that a porous nylon hydrophobic membrane obtained from GE Osmonics Labstore was put on the surface of cathode current collector, The open circuit voltage of the prototype device was measured at 3.4V.

Although examples of an integrated fuel and fuel cell device have been described, various modifications of those described devices may be made without departing from the scope or spirit of my disclosure. Those examples should not be construed as limiting scope of the device otherwise described above.

1. A device for generating electrical energy, the device comprising:
at least one fuel cell capable of generating electricity and water when fed hydrogen and oxygen, and
at least one solid fuel source comprising a solid fuel, wherein the solid fuel source is configured to produce hydrogen for use by said at least one fuel cell when reacted with the water and wherein the solid fuel source and the fuel cell are configured so that an amount of the water produced by the fuel cell is directed into the solid fuel source to react with the solid fuel to produce hydrogen for use by the fuel cell.

2. The device according to claim 1 wherein the solid fuel source comprises at least one member selected from metals; alkali metals; alkaline earth metals; hydride salts of metals, alkali metals, and alkaline earth metals and complex salts thereof; and borohydride salts of alkali metals, alkaline earth metals, ammonium, and alkyl ammonium.

3. The device according to claim 1 wherein the solid fuel source comprises at least one member selected from.

4. The device according to claim 1 wherein the solid fuel source comprises at least one member selected from sodium, lithium, potassium, and rubidium.

5. The device according to claim 1 wherein the solid fuel source comprises at least one member selected from MgH₄, NaAlH4, LiAlH₄, KAlH₄, NaGaH₄, LiGaH₄, KGaH₄, Mg(AlH₄)₂, 2Li₃AlH₆, Na₃AlH₆, and Mg₂NiH₄.

6. The device according to claim 1 wherein the solid fuel source comprises at least one member from NaBH₄, LiBH₄, KBH₄, Mg(BH₄)₂, Ca(BH₄)₂, NH₄BH₄, and (CH₃)₄NH₄BH₄.

7. The device according to claim 6, wherein the solid fuel comprises NaBH₄.

8. The device according to claim 1 wherein the solid fuel source comprises at least two members selected from the members recited in claims 2-6.

9. The device according to claim 2 further comprising a catalyst for catalyzing the reaction of the solid fuel to produce hydrogen.

10. The device according to claim 9 wherein the catalyst is present in an amount of 0.1 wt %-10 wt %.

11. The device according to claim 3 further comprising a stabilizer for stabilizing the reaction of the solid fuel to produce hydrogen.

12. The device according to claim 1 further comprising a water barrier adjacent the at least one fuel cell, wherein the water barrier is configured to be permeable to oxygen and substantially impermeable to water.

13. The device according to claim 12 wherein the water barrier comprises PTFE.

14. The device according to claim 1 claims comprising a single fuel cell.

15. The device according to claim 1 comprising multiple fuel cells.

16. The device according to claim 1 further comprising an activator containing an activating agent, wherein the activator is configured to release the activating agent to the device to initiate the generation of electricity.

17. The device according to claim 16 wherein the activating agent is water

18. The device according to claim 18 wherein the activating agent is hydrogen.

19. The device according to claim 16 wherein the device further comprises an activation barrier, wherein the activation barrier is configured to prevent the activating agent from releasing into the device and wherein the activation barrier is configured to be modified to allow the activator to release the activating agent to the device.

20. The device according to claim 19 wherein the activation barrier is comprised of a material which is impermeable to the activating agent.

21. The device according to claim 1 wherein the fuel source is a removable.

22. The device according to claim 1 further comprising a water control system, wherein the water control system is configured to control the passage of the water produced by the fuel cell back to the fuel source.

23. The device according to claim 22 wherein the water control system comprises a pressure sensitive switch which is configured to prevent the water produced by the fuel cell from reaching the fuel source when the pressure in the system is above a critical value.

24. The device according to claim 22 wherein the water control system comprises a pressure sensitive regulator which is configured to prevent the water produced by the fuel cell from reaching the fuel source when the pressure in the system is above a critical value and is configured to regulate the amount of water which passes the water control system to the fuel source based on the pressure in the system, below the critical pressure.

25. The device according to claim 23 wherein the pressure sensitive switch is mechanical.

26. The device according to claim 23 wherein the pressure sensitive switch is a chemical material having openings the size of which are sensitive to the pressure in the system.

27. The device according to claim 24 wherein the pressure sensitive regulator is mechanical.

28. The device according to claim 24 wherein the pressure sensitive regulator is a chemical material having openings the size of which are sensitive to the pressure in the system.

29. The device according to claim 24 further comprising a water storage container in communication with the fuel cell and the fuel source for storing the water produced by the fuel cell which is prevented from entering the fuel source.

30. The device according to claim 1 wherein the solid fuel source contains individual capsules which contain the solid fuel and a reaction product, wherein the capsules are permeable to the water and the hydrogen but.

31. The device according to claim 29, wherein the water storage container contains a foam material configured to absorb the water.

32. The device according to claim 31 wherein the foam material is a hydrogel.

33. The device according to claim 26 wherein the chemical material is selected from a group consisting of metal, PTFE, Nylon, carbon, and polymers such as Polyurethane, and poly 2-(acrylamindo)-2-methylpropanesulfonic acid (PAMPS).

34. The device according to claim 30 wherein the capsules are made from a pressure sensitive material which is configured to prevent the passage of water to the solid fuel contained in the capsules when a pressure in the system is at or above a critical pressure.

35. The device according to claim 34 wherein the chemical material is selected from a group consisting of metal, PTFE, Nylon, carbon, and polymers such as Polyurethane, and poly 2-(acrylamindo)-2 methylpropanesulfonic acid (PAMPS).

36. A method for generating electricity the method comprising:
reacting a solid fuel with water to generate hydrogen;
converting the hydrogen in a fuel cell to electricity and water;
directing an amount of the water produced by the hydrogen fuel cell to the solid fuel to generate hydrogen;

37. The method according to claim 36 further comprising:
controlling the amount of water which is directed to the solid fuel source, wherein the amount of water which gets directed to the solid fuel source depends on an electrical demand.

38. The method according to claim 37 wherein a decrease in electrical demand is manifested by an increase in a pressure, and wherein the pressure is used to control the amount of water gets directed to the solid fuel source

39. The method according to claim 36 further comprising:
activating the solid fuel by introducing an activating agent from an activator.

40. The method according to claim 39 wherein the activating agent is selected from a group consisting of H₂ and H₂O.

41. The method according to claim 36 wherein the number of moles of hydrogen produced per total mass of solid fuel and water used is increased when the water which reacts with the solid fuel is the water produced by the fuel cell.

42. The method according to claim 36 wherein the solid fuel solid fuel source comprises at least one member selected from sodium, lithium, potassium, and rubidium.

43. The method according to claim 36 wherein the solid fuel solid fuel source comprises at least one member selected from MgH₄, NaAlH4, LiAlH₄, KAlH₄, NaGaH₄, LiGaH₄, KGaH₄, Mg(AlH₄)₂, 2Li₃AlH₆, Na₃AlH₆, and Mg₂NiH₄.

44. The method according to claim 36 wherein the solid fuel solid fuel source comprises at least one member from NaBH₄, LiBH₄, KBH₄, Mg(BH₄)₂, Ca(BH₄)₂, NH₄BH₄, and (CH₃)₄NH₄BH₄.
